(19) United States
(12) Patent Application Publication
(10) Pub. No.: US 2023/0257186 A1
(43) Pub. Date: Aug. 17, 2023

(54) THERMALLY INSULATED FLEXIBLE CONTAINER

(71) Applicant: BALCAN INNOVATIONS INC., Vancouver (CA)

(72) Inventor: Furio OROLOGIO, King City (CA)

(21) Appl. No.: 18/009,421

(22) PCT Filed: Jun. 9, 2021
(86) PCT No.: PCT/CA2021/050785

§ 371 Date: Dec. 9, 2022

(30) Foreign Application Priority Data
Jun. 9, 2020 (CA) 3,082,753

(51) Int. Cl. B65D 81/38; B32B 27/36; B32B 7/12; B32B 27/32; B32B 27/08; B32B 3/28; B32B 15/20; B32B 15/085; B32B 27/30

(52) U.S. Cl. CPC B65D 81/3897; B32B 27/36; B32B 7/12; B32B 27/32; B32B 27/08; B32B 3/28; B32B 15/20; B32B 15/085; B32B 27/306; B32B 2255/10; B32B 2255/205; B32B 2270/00; B32B 2439/46

(57) ABSTRACT

Described are various embodiments of a flexible container, envelope or enclosure having one or more sealable side pouches for maintaining therein a material capable of transferring or extracting heat to or from a sealable inner compartment. The flexible container, envelope or enclosure is generally formed by layering and folding an inner thermally-conductive material sheet and substantially non-thermally-conductive outer sheet of material and sealing about the open edges thereof so as to form distinct compartments of the side pouches, and the inner compartment. Each of the side pouches and inner compartment may be reversibly sealable. In some embodiments the outer sheet is a made from a reflective insulated metalized polymeric bubble sheet.

### RELATED APPLICATION

The present application is related to and claims benefit of priority to Canadian Patent Application serial number 3,082,753, filed Jun. 9, 2020 and entitled “THERMALLY INSULATED FLEXIBLE CONTAINER”, the disclosure of which is herein fully incorporated by reference.

### FIELD OF THE DISCLOSURE

The present disclosure relates to thermally insulated articles, and, in particular, to a thermally insulated flexible container.

### BACKGROUND

Thermally insulated flexible containers may be used to transport object or samples which may require thermally regulated environment. For example, biological samples (dead or alive), pharmaceuticals or other objects may require a substantially cold temperature to be transported without being damaged or degraded. In other cases, objects such as food products may require a warm or hot temperature. While there exists thermally insulated flexible containers, such as bags, or envelopes or the like, these may be inconvenient to use.

International Patent Application serial number PCT/AU97/00047, entitled “PORTABLE FLEXIBLE CONTAINER FOR KEEPING ARTICLES COLD”, filed Jan. 29, 1997 published to Mitchell describes an envelope for keeping susceptible materials such as drugs within an acceptable temperature. Such an envelope comprises an inner envelope shape made by sheets of plastic having a plurality of separate cells having liquid or liquid-like material to be frozen contained therein, the inner envelope shape configured so that the cells once frozen solid may pivot with respect to one another about their mutual joint area made of pliable plastic, thus providing some degree of flexibility; this inner envelope being contained within an insulating outer envelope shape made of plastic material in a bubble formation which may also comprise metallised reflective material. To prevent an article of being inserted between the inner and outer envelope shapes, the outer edges of the inner envelope are welded or otherwise adhered to or joined to the outer edges of the outer envelope around the mutual opening area.

U.S. Pat. No. 6,139,188, entitled “INSULATED TRANSIT BAG”, issued Oct. 31, 2000 to Marzano describes an insulated transit bag for transporting heat-sensitive medicines or similar. Such a bag is made from two sheets of bubble-wrap material bonded to aluminum foil doubled-over, and heat welded to form sealed seams. At the mouth of the bag, the inner sheet and outer sheet are generally sealed together, either via adhesive tape or heat welded, so as to prevent a person from inserting an item between the inner and outer sheets. Generally, the same type of sheet may be preferred for the outer and inner sheets. In some cases, the space between the inner sheet and outer sheet may be inflated to provide extra packing and better insulation.

U.S. Patent Application Publication Number 2008/0093426, entitled “BUBBLE MAILER CHILL PACK ENVELOPE”, filed Oct. 23, 2007 to Kricher J R. describes a temperature insulated shock resistant mailer system. Such a system comprises an inner thermal container with cooling means for maintaining a low temperature, which may be removably inserted and sealed within a bubble wrap mailer envelope with layers of vapor and moisture proof thermal insulation. The mailer envelope comprises a top sheet and a bottom sheet, each sheet having bubble wrap material with insulating and shock absorbing air bubbles interconnected by plastic sheeting. The two sheets are heat sealed together to form a seam around the periphery of the two sheets with an opening at one end. The inner thermal container preferably comprises a pair of mating shells of molded light weight expanded polystyrene. At least one, and preferably both, of the pair of mating shells has a recessed interior retain the temperature sensitive material being shipped and the means for maintaining the temperature sensitive material at a cold temperature within the recessed interior.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

In accordance with one aspect, there is provided a flexible container comprising an interior compartment made from a first sheet folded to define a pair of interior panels, each interior panel having a pair of lateral edges and each interior panel being sealed so as to join one interior panel to the other near the lateral edges. Each interior panel has a distal edge located opposite the fold and when said interior panels are sealed the lateral edges define an opening of said interior compartment. The fold of the first sheet defines a bottom edge of said interior compartment where one or more side pouches located outwardly of the interior compartment and made from a second sheet folded to define a pair of exterior panels. Each exterior panel has a pair of lateral edges and each exterior panel is sealed so as to join one exterior panel to the other near the lateral edges. Each exterior panel has a distal edge located opposite the fold and when the exterior panels are sealed the lateral edges thereof define an opening for receiving therein the interior compartment, where the fold of the interior compartment is received in parallel alignment and near the fold of the second sheet. The fold of the second sheet defines a bottom edge of the flexible container. Each of the one or more side pouches is operable to contain therein a material capable of exchanging heat with the interior compartment and each of the one or more side pouches being defined on one side by one of said interior panels and a corresponding adjacent one of the exterior panels.

In one embodiment, the lateral edges of the interior panels and the lateral edges of the exterior panels are sealed together.

In one embodiment, at least one the distal edge of the interior panels extends beyond the distal edge of the exterior panels.

In one embodiment, the second sheet is configured so that the fold thereof is joined with the fold of said first sheet, so as to create separated side pouches.

In one embodiment, the outer sheet is configured so that the fold thereof rests above the fold of said inner sheet.

In one embodiment, the fold of the first sheet is hermetically and selectively reversibly coupled with the fold of the second sheet.

In one embodiment, the hermetically and reversibly coupling is provided by a breakable membrane.

In one embodiment, one of said hermitically-sealed side pouches is filled with a first substance and the other is filled with a second substance; the first and second substances permitted to contact one another upon selective uncoupling of the fold of the first sheet and the fold of the second sheet.

In one embodiment, the first substance and the second substance chemically react endothermically or exothermically.

In one embodiment, the second sheet is made from a thermally-insulated material.

In one embodiment, the thermally-insulated material comprises reflective polymeric bubble pack insulation.

In one embodiment, the first sheet is made from a substantially thermally-conducting material.

In one embodiment, the opening of said interior compartment comprises a closure mechanism affixed thereto.

In one embodiment, the closure mechanism comprises at least one of a zipper, one or more buttons, adhesive tape, one or more Velcro® patches, one or more magnets.

In one embodiment, the closure mechanism comprises a pressure-enabled closing mechanism.

In one embodiment, the lateral edges of said first sheet and/or said second sheet are heat-sealed, sewed or glued.

In one embodiment, the flexible container further comprises one or more handle affixed thereto.

In accordance with another aspect, there is provided a flexible container which to comprises an interior compartment and one or more sealable outer compartments located outwardly of said interior compartment. The interior compartment is comprised of a sheet of thermally-conductive material formed into at least one thermally-conductive sidewall region and a thermally-conductive bottom region so as to define the interior compartment. The one or more sealable outer compartments is defined by a sheet of a thermally-insulative material formed into a least one thermally-insulative sidewall region and a thermally-insulative bottom region and having the interior compartment received therein. The one or more outer compartments is defined as a space between said least one thermally-conductive sidewall region and said thermally-conductive bottom region of the interior compartment and the least one thermally-insulative sidewall region and said thermally-insulative bottom region.

In one embodiment, the thermally-insulative material is a polymeric bubble pack sheet.

In one embodiment, the thermally-insulative material is a reflective metalized polymeric bubble pack sheet.

In one embodiment, the sheet of thermally-conductive material is folded and sealed near the respective lateral edges thereof so as to form the interior compartment, the fold being the thermally-conductive bottom region.

In one embodiment, the sheet of thermally-insulative material is folded and sealed near the respective lateral edges thereof, the fold being the thermally-insulative bottom region.

In one embodiment, the respective lateral edges of said thermally-conductive sheet and said thermally-insulative sheet, when folded, are sealed so as to form two sealable outer compartments.

In one embodiment, the interior compartment is sealable.

In one embodiment, the interior compartment is selectively reversibly sealable.

In one embodiment, the thermally-conductive bottom region and said thermally-insulative bottom region are coupled to form two distinct outer compartments.

In one embodiment, the one or more sealable outer compartments contain a material capable of exchanging heat with the interior compartment.

In one embodiment, the thermally-conductive bottom region and said thermally-insulative bottom region are hermetically and selectively reversibly coupled to form two distinct outer compartments.

In one embodiment, the hermetically and reversibly coupling is provided by a breakable membrane.

In one embodiment, one of said hermitically-sealed outer compartments is filled with a first substance and the other is filled with a second substance. The first and second substances are permitted to contact one another upon selective uncoupling of the thermally-conductive bottom region and said thermally-insulative bottom region. In one embodiment, the first substance and the second substance chemically react endothermically or exothermically.

In accordance with another aspect, there is provided a flexible container made from a folded insulated outer sheet where the fold of said folded insulated outer sheet defines a bottom edge of the flexible container and the lateral edges of the folded outer sheet are sealed so as to provide and exterior vessel and an inner sheet of a thermally-conductive material is provided where the fold of the inner sheet defines a bottom edge of an interior compartment and the lateral edges of said folded inner sheet are sealed so as to provide an interior vessel defining a flexible container interior compartment. The fold of the inner sheet is received in the folder of said outer sheet so as provide a space between exterior vessel and the interior vessel, and wherein the space is sealable so as to define at least one outer compartment.

In one embodiment, the interior compartment is selectively reversibly sealable.

In one embodiment, the fold of the inner sheet and the fold of the outer sheet are joined such that the space between the inner vessel and the outer vessel defines two or more outer compartments on each side of the interior compartment, each outer compartment operable to contain therein a material capable of exchanging heat with the interior compartment.

In one embodiment, the outer compartments are sealed.

In one embodiment, the outer compartments are selectively reversibly sealable.

In one embodiment, the one or more sealable outer compartments contain a material capable of exchanging heat with the interior compartment.

In one embodiment, the two or more outer compartments are hermetically and reversibly coupled by a breakable seal.

In one embodiment, the one of the hermitically-sealed outer compartments is filled with a first substance and another is filled with a second substance. The first and second substances are permitted to contact one another upon selective uncoupling of the thermally-conductive bottom region and the thermally-insulative bottom region.

In one embodiment, the first substance and the second substance chemically react endothermically or exothermically.

In one embodiment, the insulated outer sheet is a polymeric bubble pack sheet.

In one embodiment, the insulated outer sheet is a reflective metalized polymeric bubble pack sheet.

In accordance with another aspect, there is provided a method for producing a thermally-insulative flexible container comprising: providing a thermally-insulative sheet in layered arrangement with a thermally-conductive sheet of equal or lesser dimensions; folding said thermally-insulative sheet and said thermally-conductive sheet together such that the thermally-conductive sheet is inside the thermally-insulative sheet; sealing the near lateral sides of the thermally-conductive sheet and the laterals sides of the thermally-insulative sheet such that the thermally-conductive sheet forms an interior compartment and the thermally-insulative sheet forms one or more exterior compartments with void therebetween; installing in the void a material capable of exchanging heat with the interior compartment across the thermally-conductive sheet and sealing the void so as to contain the material capable of exchanging heat in the void.

In one embodiment, the interior compartment is reversibly sealable.

In one embodiment, the sealing near the lateral sides of the thermally-conductive sheet and the thermally-insulative sheet joins the lateral sides of the thermally-conductive sheet to the thermally-insulative sheet so as to define at least two outer voids.

In one embodiment, the fold of the thermally-insulative sheet and the fold of the thermally-conductive sheet are coupled.

In one embodiment, the thermally-insulative sheet is a polymeric bubble pack sheet.

In one embodiment, the thermally-insulative sheet is a reflective metalized polymeric bubble pack sheet.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1A is 1B a schematic perspective view of an exemplary embodiments of a thermally-insulated flexible container comprising side pouches;

FIG. 1B is a top view of a thermally-insulated flexible container of FIG. 1;

FIGS. 2A to 2C are schematic diagrams illustrating a folding process for making the flexible container of FIGS. 1A and 1B, in accordance with one embodiment;

FIGS. 3A to 3C are schematic diagrams illustrating the flexible container of FIGS. 1A and 1B showing exemplary relative dimensions and orientations of various components, in accordance with another embodiment;

FIG. 4 is a perspective view of the flexible container of FIGS. 1A and 1B, with the outer sheet folded into uneven portions, in accordance with another embodiment;

FIGS. 5A to 5D are a top view, perspective view, top view and a second perspective view, respectively, of the flexible container of FIGS. 1A and 1B with the outer sheet having an increased width with respect to the inner sheet, in accordance with another embodiment;

FIGS. 6A and 6B are perspective views of the flexible container of FIGS. 1A and 1B with outer sheet having a reduced width with respect to the inner sheet, in accordance with another embodiment;

FIG. 7 is a diagrammatic perspective view of an insulating sheet (in part) in accordance with one embodiment;

FIGS. 8 and 9 are diagrammatic cross-sectional views through a reflective metalized insulation bubble pack having an interposed aluminum foil or metalized polymeric film, in accordance with one embodiment; and

FIGS. 10 to 15 represent diagrammatic, exploded sectional views of bubble pack assemblies wherein the same numerals denote like parts, in accordance with different embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

Additionally, unless otherwise noted, the term “metalized” is used broadly to encompass “metals” (and vice versa), such as metal foils, metal depositions, and the like.

The systems and methods described herein provide, in accordance with different embodiments, different examples in which objects may transported while being conveniently cooled or warmed by means of a thermally insulated flexible container comprising an interior compartment for storing said objects and one or more, generally, two peripheral side pouches located outwardly of the interior compartment, for storing thermal regulation objects, devices or chemicals capable of providing heat or cooling. These described embodiments are consistently effective at keeping the interior compartment cool or warm.

In general, the thermally insulated flexible container may comprise an interior compartment for storing objects or substances. These may include, without limitation, organic material or samples, such as animal or human samples, organs, food products; or temperature-sensitive substances such as chemicals. Each flexible container also comprises one or more, generally, two peripheral side pouches located outwardly of the interior compartment side pouches on each side, as will be described in more details below, for storing one or more thermal regulation object, device or chemical capable of providing heat or cooling. These devices or chemicals may include ice/cold or heat/hot packs or any similar device using phase change materials, battery powered cooling or heating devices, or even separated mixable chemicals conjunctions designed to produce cold or heat upon being mixed, as will be detailed below in various examples.

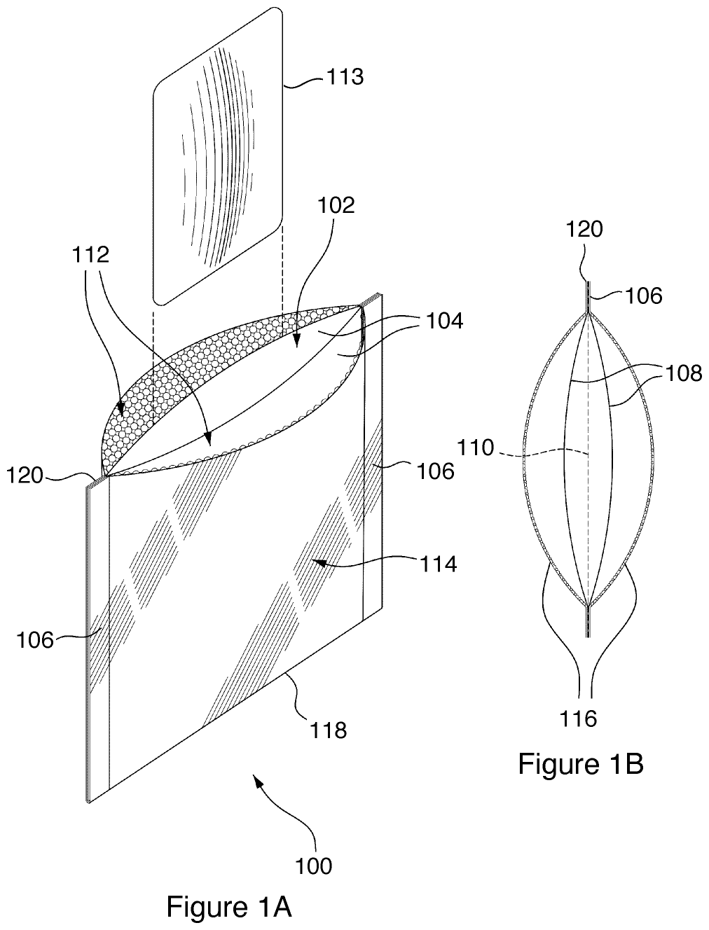

With reference to FIGS. 1A and 1B, and in accordance with one embodiment, an exemplary thermally insulated flexible container 100, referred using the numeral 100, will now be described. For example, in the flexible container 100 may fashioned as a flexible container or as an envelope in the various embodiments disclosed herein. In this embodiment, flexible container 100 comprises an interior compartment 102, defined by the space enclosed between two interior panels 104 and two side edges 106, two opening edges 108 and a bottom edge 110. Although not shown in the figures for simplicity, more than one inner compartment 102 made be provided, in some embodiments, of which one of skill in the art would know how to form from a reading of the instant disclosure. Furthermore, flexible container 100 comprises two external or side pouches 112 located exteriorly on each side of the interior compartment 102, such that each pouch 112 is in contact with a corresponding interior panel 104. The interior portion of each of side pouches 112 may be defined by the space formed between one of external panels 114, each having a corresponding opening edge 116, and the corresponding adjacent interior panel 104 with its corresponding opening edge 108, an external panel bottom edge 118 and two side edges 120. In the presently disclosed embodiment of FIGS. 1A and 1B, the sealed side edges 106 and 120 are shown as being sealed together or jointly. However, this may be different in other embodiments as will be discussed below.

As mentioned above, flexible container 100 may be used to contain or enclose different types of objects or materials (including biological materials) which may require a temperature that is substantially higher or lower than room temperature. Thus, side pouches 112 may be used, in some embodiments, to store or contain heat regulating objects, devices or chemicals, for example so-called ice packs or heat packs or pads, thereby keeping the contents or objects inside interior compartment 102 of flexible container 100 cold or hot, respectively. The temperature regulating object, device or chemicals may be stored in either or both pouches, as needed. An example of this is illustrated in FIG. 1 wherein an exemplary freezer pack 113 is shown being inserted into one of side pouches 112. Generally, any container comprising a phase-change material (the most common being water but other substances are known in the art) operable to emit or absorb heat may be used. Similarly, containers/flexible containers/packs comprising chemically-reactive materials or substances designed to provide cold or heat may also be used individually and stored within each of side pouches 112. Alternatively, the phase-change materials, or other means capable of providing heat or cooling may be placed, and in some embodiments sealed or otherwise maintain directly in the one or more side pouches 112.

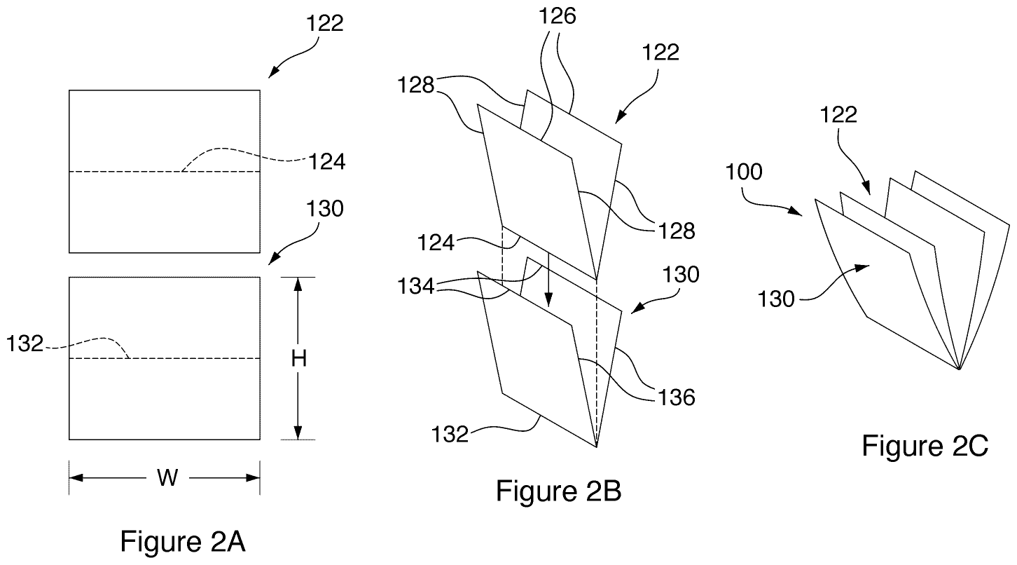

With reference to FIGS. 2A to 2C, and in accordance with one embodiment, an exemplary method for fabricating or assembling flexible container 100 will now be discussed. In this exemplary embodiment, interior compartment 102 of flexible container 100, as shown in FIG. 1A for example, may be realized by taking a first sheet or inner sheet 122 of a substantially flexible material and folding it, in this example, into equal parts. The inner sheet, in preferred embodiments, is generally made from a non-porous material. The fold or fold line 124 may be parallel to any two distal edges 126, which, once the first sheet 122 is folded, form the corresponding opening edges 108 of said interior compartment 102. The fold or fold line 124 itself (as shown in FIGS. 2A and 2B) therefrom becomes bottom edge 110, as shown in FIG. 1B, of said interior compartment 102, and each of two adjacent peripheral edges 128 of inner sheet 122 oriented perpendicularly to fold 124 (as shown in FIG. 2C), may be sealed or affixed one to another, forming therefrom the side edges 106 of interior compartment 102, as shown in FIG. 1B.

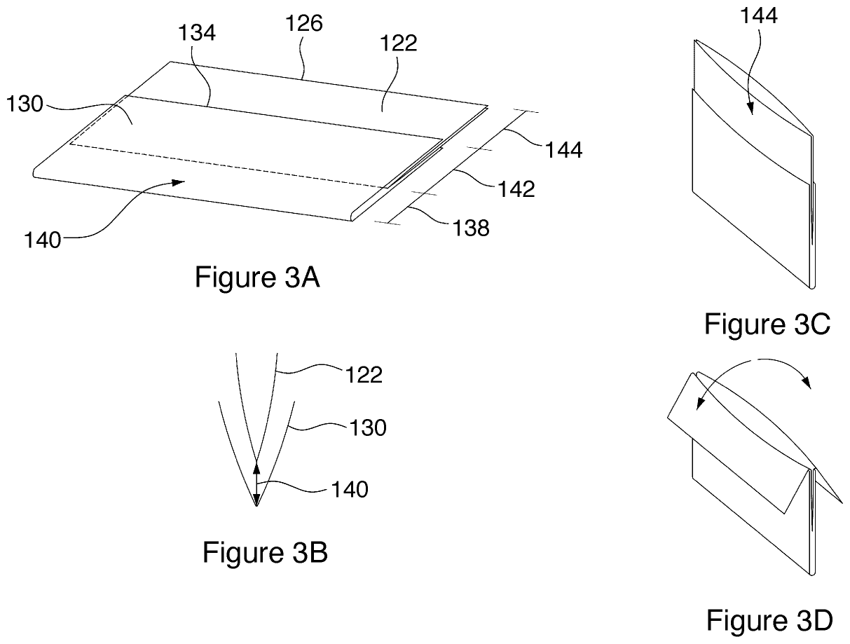

Flexible container 100 also comprises one or more, and as shown the figures, generally two side or external pouches 112 located outwardly on each side of interior compartment 102. These may be formed by folding an outer sheet 130 of a substantially flexible material so as to substantially encompass within folded first sheet 122 as shown in FIGS. 2B and 2C, and as to substantially align fold line 132 of folded second sheet 130 with fold line 124 of folded inner sheet 122. Again, the fold or fold line 132 may be parallel to any two distal edges 134, which, once first sheet 130 is folded, form the corresponding opening edges 116 of side pouches 112, as shown in FIGS. 1A and 1B. Furthermore, the outer sheet 130 is generally made from a non-porous materials, in preferred embodiments. However, in certain embodiments, one may desire or require that the outer sheet 130 be fashioned from a porous material. As shown in FIGS. 2B and 2C, in this exemplary embodiment, folds 124 and 132 may be adjoined, affixed, glued or sealed together but in other embodiments, some of which are discussed below, the folds may not be directly in contact, with fold 124 resting above fold 132, as shown, for example in FIG. 3B. Moreover, the two side edges 120 of each pouch may be formed by sealing adjacent peripheral side edges 136 of outer sheet 130 together.

Sheets 122 and 130 shown in FIG. 2A are shown as square or rectangular sheets and as having the same shape and size as an example only. Generally, different embodiments may be envisioned wherein the dimensions of sheets 122 and 130 may change or differ from the present example. For example, a user may desire a change in the dimensions of interior sheet 122 and outer 130 dependent on the temperature control needs of the item to be stored in the interior compartment 102 and/or the characteristics phase-change materials, or other means capable of providing heat or cooling. Thus, with reference to other embodiments discussed below, the width (dimension W, as shown in FIG. 2A) a sheet will be defined as the length along distal edges 126 or 134 (i.e. parallel to the fold), while the height (dimension H, as shown in FIG. 2A) of a sheet will be defined as the length along peripheral edges 128 or 136 (i.e. perpendicular to the fold). Moreover, in some embodiments, the fold lines may divide each of sheets 122 and 130 into unequal parts, as will be discussed below.

Notably, in the exemplary embodiment of FIGS. 1A and 1B and FIGS. 2A and 2C, edges 134 are shown to be sealed on top of corresponding sealed edges 128. Such sealing may be done by means conventionally known in the art for sealing enclosures such as flexible containers or envelopes, such as, for example, an adhesive means, a Zip-loc™ means, melting of the materials together, or other suitable means so as to enclose the side pouches 112 as may desired by a user in a given application. However, this may not be the case of all embodiments, as will be discussed below, and thus in these cases where the width of sheet 130 is smaller than the width of sheet 122, or in cases where inner sheet 122 and outer sheet 130, once folded, are not centered with respect to one another, at least one of peripheral side edges 136 may have to be sealed onto the adjacent surface of inner panel 104 formed by inner sheet 122, as will be discussed below.

Different means of sealing edges of sheet 122 and/or sheet 130 together may be envisioned, without limitation. This may include for example heat-sealing, gluing, stitching or similar, as indicated above. Such sealing methods may also include, for example and without limitation, an adhesive means, a Zip-loc™ means, melting of the materials together, zippers, hooks, buttons, adhesive tape, Velcro®, magnets or pressure-enabled closing mechanisms or other suitable means so as to enclose the side pouches 112.

Moreover, different types of materials or combinations thereof may be envisioned for sheet 122 and sheet 130. For example, in some embodiments, inner sheet 122 and/or sheet 130 may be made from a substantially impermeable material or non-porous materials, as indicated above. In some embodiments, for example if the contents of interior compartment 102 are to be kept at a cold and/or hot temperature, the material of inner sheet 122 may be made from a substantially thermally-conductive material, while in contrast the material of outer sheet 130 may be chosen from a substantially thermally non-conductive material. For example, the thermally-conductive materials may be a metal sheet, a paper sheet, or a polymeric sheet. For example, the substantially thermally non-conductive material in preferred embodiments, may be a bubble pack material or a metalized bubble pack material. Thus, in this example, the content of side pouches 112 may be kept in good thermal contact with the contents of interior compartment 102, while also being isolated from the outside environment. Any thermally insulating materials may be considered, including for example, a reflective polymeric bubble pack insulation material or similar, as noted above. Examples of suitable reflective polymeric bubble pack insulation materials may similar or identical to those known in the construction industry, particularly for use in residential, commercial, and industrial buildings and establishments, wherein the insulation material is adjacent frame structures, walls, crawl spaces, ceilings, around water heaters and pipes and under concrete floors and roads. Examples of such reflective polymeric bubble pack insulation materials are disclosed in U.S. Pat. No. 6,322,873—issued Nov. 27, 2001 to Orologio, Furio and U.S. Pat. No. 6,562,439—issued May 13, 2003 to Orologio, Furio; Canadian Patent No. 2,554,754—issued Dec. 4, 2007 to Orologio, Furio; and U.S. Pat. No. 10,112,364—issued Oct. 30, 2018 to Orologio, Furio. More details regarding the substantially thermally non-conductive material, such as a bubble pack material or a metalized bubble pack material from which the outer sheet 130 may be made are provided further below.

In some embodiments, flexible container 100 may also comprise one or more closure mechanisms for closing inner compartment and/or side pouches. For example, the closure mechanism used to adjoint or seal opening edges 108 (e.g. for closing or sealing interior compartment 102), or one of inner edges 108 and adjacent one of outer edges 116 (e.g. for closing one of side pouches 112) may take any form known in the art. These may include, without limitation, an adhesive means, a Zip-loc™ means, melting of the materials together, zippers, hooks, buttons, adhesive tape, Velcro®, magnets or pressure-enabled closing mechanisms or other suitable means.

In some embodiments, flexible container 100 may also comprise one or more handles or similar. These may have different lengths and sizes. For example, handles may be affixed to flexible container 100 or other embodiments on either one of outer panels 114, to the opening edges 108 and/or 116, to portions of interior panels 104 which may be uncovered (see below) or to another location entirely. Any fixation mechanism may be used, for example the handles may be sewed or glued. The skilled technician will understand that there are many ways handles may be affixed to the flexible container known in the art.

In another embodiment, as illustrated in the schematic diagrams of FIGS. 3A to 3C, once folded, flexible container 100 may be configured instead so that fold 124 of inner sheet 122 rests above fold 132 of outer sheet 130 for a height or distance 138. This creates, once the sheets are folded and sealed, a connecting area 140 below interior compartment 102 which connects the inner volume of each of side pouches 112, as illustrated in FIGS. 3B and 3C. Moreover, sheets 122 and 130 may be sealed together along their corresponding adjacent peripheral side edges 128 and 136 along length 142 shown in FIG. 3A. Any value of height 138 may be chosen as long as outer sheet 130 covers at least in part inner sheet 122 via adjacent edges along length 142 so that they may be sealed or affixed together.

In some embodiments, a thin impermeable and breakable membrane (not shown) may be affixed or placed so as to hermetically cover connecting area 140 to prevent any substance from one pouch of side pouches 112 to come into contact with another substance from the other pouch. Thus, for example, side pouches 112 may be hermetically sealed after being filled with a chemically reactive substance or concoction, said substances upon being mixed together reacting via an endothermic or exothermic chemical reaction, therefore transferring or extracting heat from interior compartment 102 so as to change or modulate the temperature within interior compartment 102 (e.g. cool or warm respectively) which is in thermal contact with side pouches 112. In some embodiments, the substances may be in the form of a liquid or gel. In some embodiments, one pouch may contain a substantially liquid-like substance while the other pouch may contain a solid substance, for example but without limitation in the form of a powder, grains, disks, tablets, etc. The skilled technician will understand that different substances, and concentrations thereof, may be used to provide for the desired change in temperature.

Thus, the presence of a breakable membrane may ensure that the substances are separated until a user of the flexible container desires to enable the heating or cooling of the interior compartment 102. At that time, the membrane may be ripped or broken by the user, which may cause the substances in each pouch to mix and chemically react. Such a thin breakable membrane may be configured to be ripped or broken, for example, by a twisting or shearing motion of the flexible container at the location or in the vicinity of the location comprising connecting area 140. The skilled artisan will understand that exact size and shape of the thin breakable membrane may change depending on the way sheets 122 and 130 are arrange or configured with respect to one another prior to being sealed together, without limitation.

Moreover, as mentioned above, having fold 124 resting above fold 132 may result in a portion 144 of inner sheet 122 extending above distal edges 134 of outer sheet 130. If adjoining distal edges 126 of inner sheet 122 are sealed entirely, this may result in the embodiment of FIG. 3C with edges 126 becoming inner opening edges 108. However, in some embodiments, portion 144 of inner sheet 122 extending above outer sheet 130 may be used as a flap that folds back over the side pouch adjacent to the corresponding external panel 114 formed by outer sheet 130, as shown in FIG. 3D. Such a double-flap embodiment may comprise a closing mechanism affixed to it so as to be secured over the pouch's external panel 114 and therefore keep the contents within the pouch from falling out. For example, these may include, without limitation, buttons, Velcro™ patches, magnets, etc. However, in some embodiments, the height of inner sheet 122 may be chosen to be smaller than the height of outer sheet 130 specifically to avoid having extending portion 144 present. Moreover, the embodiment of FIGS. 1A to 2C (e.g. where bottom folds 124 and 132 are in contact) may also have a similar double-flap if the height of inner sheet 122 is taken or chosen to be larger than the height of outer sheet 130.

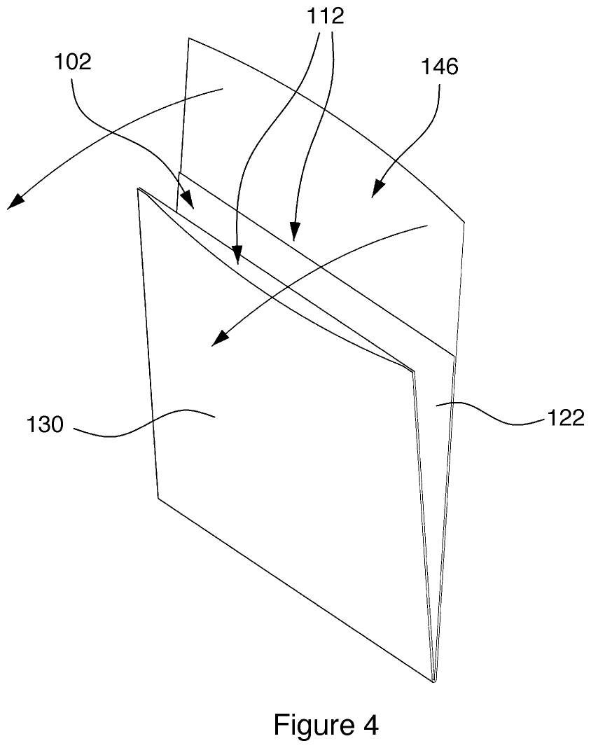

Inversely, if the height of inner sheet 122 is chosen to be smaller than the height of outer sheet 130, this may result in a portion of outer sheet 130 extending above the opening of the resulting interior compartment 102. An example of this is shown in FIGS. 4, where outer sheet 130 was folded into unequal portions and configured with respect to inner sheet 122 so that one of distal side edges 134 is aligned on one side height-wise with the corresponding adjacent peripheral edge 126 of inner sheet 122, resulting in portion 146 extending above the opening of both pouches 112 and interior compartment 102. Thus, as discussed above, extending portion 146 may be used as a flap to close both pouches 102 and interior compartment 101 simultaneously.

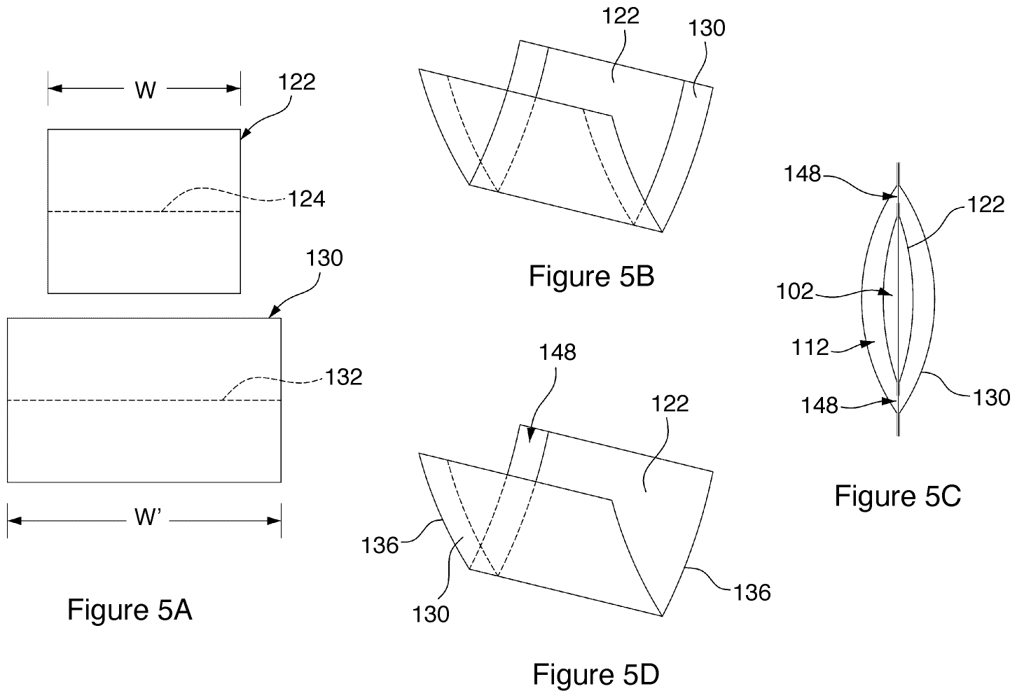

In some embodiments, inner sheet 122 may be chosen to have a width that is smaller than the width of outer sheet 130, as shown in the schematic diagrams of FIGS. 5A to 5D. Thus, in this embodiment, the disparity in width, shown as dimensions W and W′ in FIG. 5A, between the two sheets results in a connecting area 148 being formed upon outer sheet 130 being folded to enclose folded inner sheet 122. In this embodiment, inner sheet 122 may be affixed to outer sheet 130 by gluing or sealed both folds together, for example. Moreover, in this example, adjacent side edges of inner sheet 122 may be sealed together independently from side edges 136 of outer sheet 130. Like for connecting area 140 of the exemplary embodiment of FIGS. 3A to 3D discussed above, connecting area 148 may similarly be covered with a thin breakable membrane (not shown) so that each pouch may be filled with chemically reactive chemicals and hermetically sealed, similar to that as discussed above with regard to the hermetically covered connecting area 140. Moreover, again the pouches may be pre-filled and sealed upon being manufactured.

Furthermore, in FIGS. 5A to 5C above, inner sheet 122 is shown to be centered with respect to outer sheet 130 as an example only. The skilled technician will understand that inner sheet 122 may be placed or aligned anywhere along the length of fold 132 of outer sheet 130, without limitation. For example, in one embodiment, inner sheet 122 may be configured with respect to outer sheet 130 so that on one side adjacent side peripheral side edges 128 and 136 are aligned and may be sealed together, thus forming a single connecting area 148 on the opposite side, as illustrated, for example, in FIG. 5D.

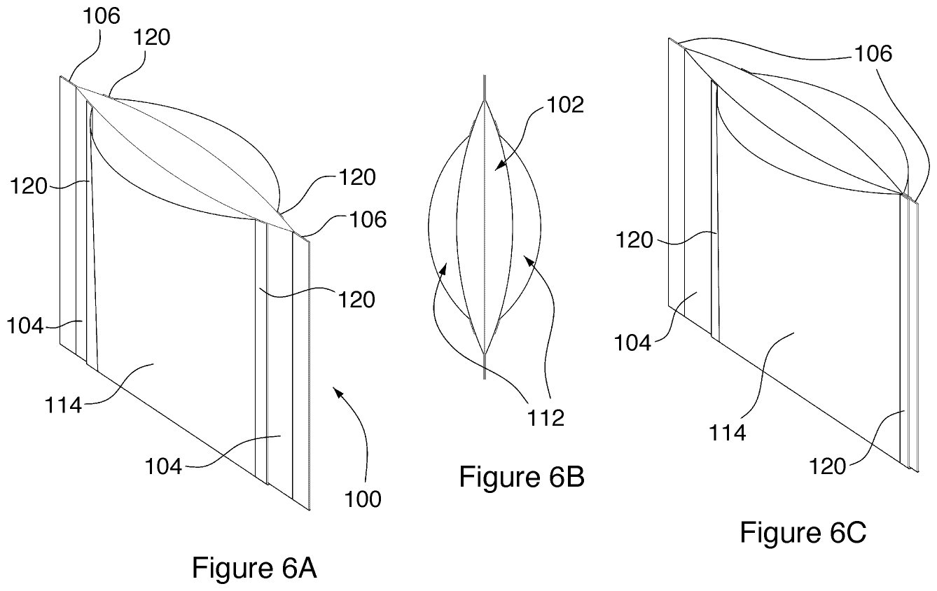

In contrast, another embodiment, shown in FIGS. 6A to 6C, may instead have the width of outer sheet 130 smaller than the width of inner sheet 122. FIG. 6A shows a perspective view of the resulting flexible container 100, wherein it is shown that the width of the resulting side pouches 112 is smaller than the width of the inner panel 104 of interior compartment 102. Thus, in this example, the outer surface of inner panel 104 may not be completely covered by or in contact with sides pouches 112. This may be useful, for example, if a specific inner volume that conforms more closely to the dimensions of a thermal regulation object is required. Moreover, outer sheet 130 may be aligned, once folded, at any point along the fold line 124 of inner sheet 122. Thus, in some embodiments, at least one of peripheral side edges 136 of outer sheet 130 may have to be sealed onto the adjacent exterior surface of inner sheet 122. An example of this is shown in the perspective view of FIG. 6C.

In some embodiments, one or more apertures or tubes (not shown) may be inserted into flexible container 100 so as to provide a tube-shaped connecting aperture between the inner volume of each side pouch. In other embodiments, one or more aperture may be added along the exterior so as to connect each the inner volume of each pouch. This may be included in any of the embodiments discussed above or any combination thereof, as will be apparent to the skilled technician.

In some embodiments, the inner sheet 122 and outer sheet 130 may not be rectangular in shape and/or may have rounded corners, without departing from the examples given above.

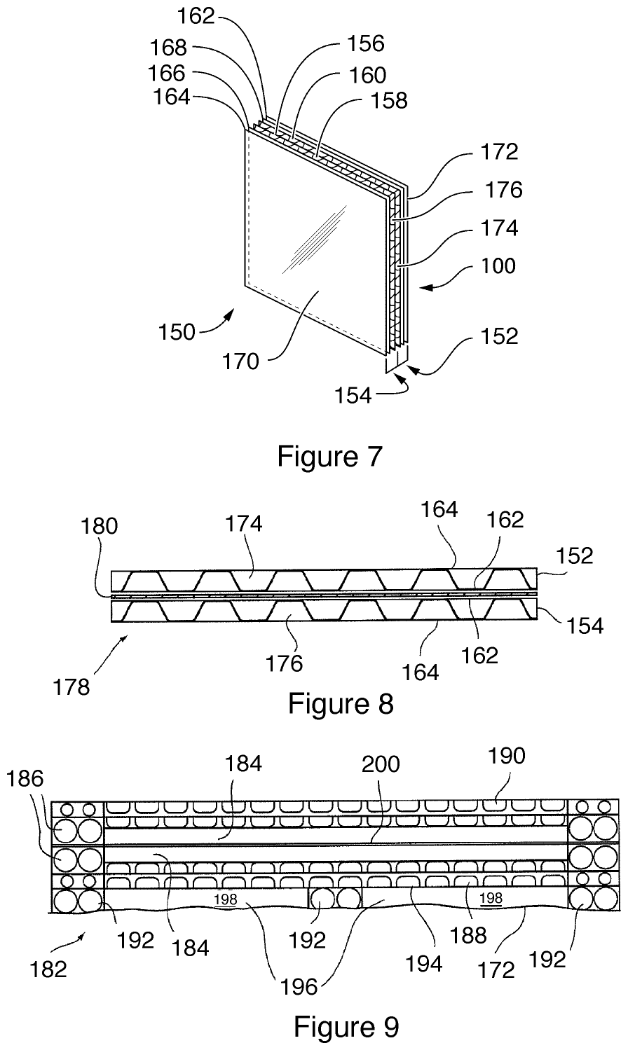

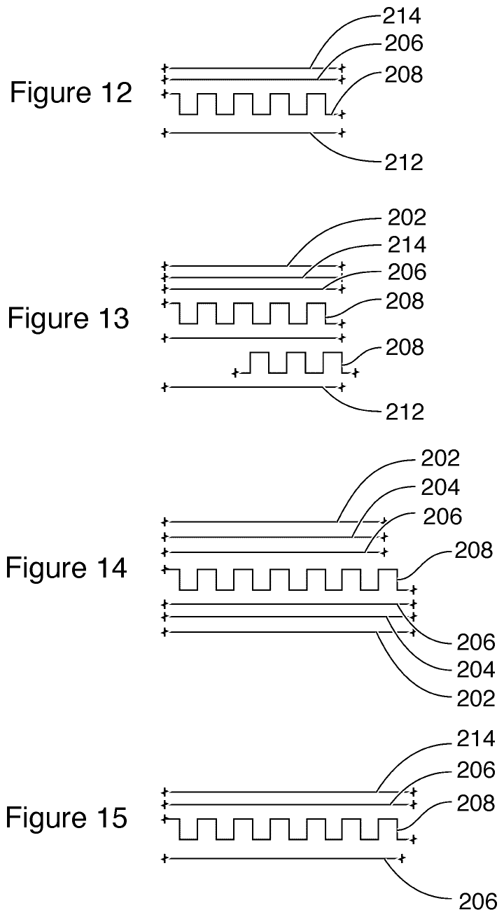

FIGS. 7 to 15 show various embodiments from which the outer sheet 130 may be made, by way of example only. It should also be noted that as used herein, the term ‘metalized’ includes, but is not limited to metals in the form of a foil and to particulate metals deposited by vapour or from the solution.

With reference to FIG. 7, this shows generally as 150, a reflective metalized polymeric insulation material or sheet comprising a double layer, bubble-pack with an aluminum foil insulation assembly. The double layer consists of a pair of bubble pack arrays 152, 154 bonded together through an intervening low-density polyethylene film 156. Arrays, 152, 154 are formed of a plurality of bubbles 158 or sealed cavities and spaces between the bubbles 160, from a 5-mil polyethylene film 162, 164, respectively. Each of films 162, 164, at their outer surfaces, is bonded to a reflective metal foil or reflective aluminum foil 166, 168, respectively, to provide the whole assembly with external aluminum surfaces. Optionally, in some embodiments, the double layer may be adhered between an outer material surface 170 and inner material surface 172.

In some embodiments, assembly 150 has approximately twenty, 1 cm diameter, 0.5 cm high bubbles per 30 cm length and breadth, given unit, within each of layers 174, 176. However, in some embodiments, a desired number of bubbles may be deleted or otherwise not formed.

The aforesaid assembly 150 is made by a double hot roller thermal and vacuum forming process for cavity forming and lamination sealing techniques known in the art.

With reference to FIG. 8, this figure generally shows at 178 composite double bubble-pack assembly, thus forming a radiant barrier, according to one embodiment, having a metal or aluminum foil 180 disposed between and bonded to bubble arrays 152 and 154 formed as for example the assembly shown in FIG. 7. Bubble layers 174 and 176 are encapsulated between polyethylene films 162 and 164, thus forming exemplary arrays.

Aluminum foil 180 has a low emissivity value of less than 5% on each surface to essentially eliminate heat transfer by radiation thus making it desirable for use in the reflective metalized polymeric insulative layer.

Each of the single bubble-pack layers 152, 154 provides both thermal conduction and convection insulation, and, in combination with the aluminum surfaces, excellent radiation insulation.

The composite bubble-pack 150 offers significant resistance to heavy loading whereby appreciative non-breakage of the air bubbles is often found. Preferably, outer layers 164 are made slightly thicker than inner layers 162 to better resist abrasion. Additional water resistance or abrasion resistant films may be bonded, formed or laminated to layer 164.

Further, in consequence that the composite assemblies of the instant disclosure may have better thermal R-values than prior art assemblies, thinner or higher insulative assemblies may be provided.

FIG. 9 shows a bubble pack generally as 182 having a pair of insulative air chambers 184 created by inner spacers 186 laminated to individual bubble packs 188, 190.

The assembly of FIG. 9, for example, also has a plurality of external spacers 192 adhered to outer layer 194 to define with layer 194, open cavities 196 which may be located adjacent to, for example, material surface 170 so as to provide an inner insulative air chamber 198 from open cavities 196 between the bubble pack assembly. Assembly 182 has a pair of aluminum laminate or metalized films 198 adhered together.

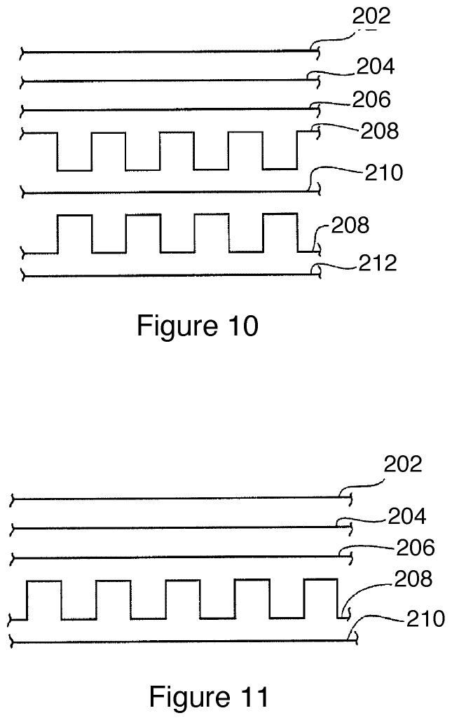

With reference to FIGS. 10 to 15 the following numerals denote the same materials throughout the drawings, as follows with reference to various exemplary metalized bubble-pack insulative layer arrangement's which may be suitable for use for outer sheet 130:
202—48 gauge aluminum metalized polyester (PET) film;
204—adhesive;
206—1.2 ml polyethylene film;
208—2.0 ml polyethylene film (bubbled);
212—1.2 ml ethylene vinyl acetate-polyethylene film;
214—2.0 ml polyethylene film; and
216—aluminum foil.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed 5 by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth to in the appended claims, as may be apparent to those of ordinary skill in the art, are also encompassed by the disclosure.

What is claimed is:

1-48. (canceled)

49. A flexible container comprising:
an interior compartment made from a first sheet folded to define a pair of interior panels, each interior panel having a pair of lateral edges and each interior panel being sealed so as to join one interior panel to the other near the lateral edges, each interior panel having a distal edge located opposite the fold and when said interior panels are sealed said lateral edges defining an opening of said interior compartment, the fold of the first sheet defining a bottom edge of said interior compartment,
one or more side pouches located outwardly of said interior compartment and made from a second sheet folded to define a pair of exterior panels, each exterior panel having a pair of lateral edges and each exterior panel being sealed so as to join one exterior panel to the other near the lateral edges, each exterior panel having a distal edge located opposite the fold and when said exterior panels are sealed said lateral edges thereof defining an opening for receiving therein the interior compartment, where the fold of the interior compartment is received in parallel alignment and near the fold of the second sheet, the fold of the second sheet defining a bottom edge of said flexible container;
each of the one or more side pouches operable to contain therein a material capable of exchanging heat with the interior compartment;
each of the one or more side pouches defined on one side by one of said interior panels and a corresponding adjacent one of the exterior panels;
wherein said second sheet is made from a thermally-insulated material, said thermally-insulated material comprising reflective polymeric bubble pack insulation.

50. The flexible container of claim 49, wherein the lateral edges of the interior panels and the lateral edges of the exterior panels are sealed together.

51. The flexible container of claim 49, wherein at least one the distal edge of the interior panels extends beyond the distal edge of the exterior panels.

52. The flexible container of claim 49, wherein said second sheet is configured so that the fold thereof is joined with the fold of said first sheet, so as to create separated side pouches.

53. The flexible container of claim 49, wherein said outer sheet is configured so that the fold thereof rests above the fold of said inner sheet.

54. The flexible container of claim 52, wherein the fold of the first sheet is hermetically and selectively reversibly coupled with the fold of the second sheet.

55. The flexible container of claim 54, wherein one of said hermitically-sealed side pouches is filled with a first substance and the other is filled with a second substance, and wherein the first and second substances are permitted to contact one another upon selective uncoupling of the fold of the first sheet and the fold of the second sheet, and wherein said first substance and said second substance chemically react when in contact.

56. The flexible container of claim 55, wherein said first substance and said second substance chemically react endothermically.

57. The flexible container of claim 49, wherein said first sheet is made from a substantially thermally-conducting material.

58. A flexible container comprising:
an interior compartment and one or more sealable outer compartments located outwardly of said interior compartment,
wherein said interior compartment comprises a sheet of thermally-conductive material formed into at least one thermally-conductive sidewall region and a thermally-conductive bottom region so as to define said interior compartment,
wherein said one or more sealable outer compartments is defined by a sheet of a thermally-insulative material formed into a least one thermally-insulative sidewall region and a thermally-insulative bottom region and having said interior compartment received therein, said one or more outer compartments being defined as a space between said least one thermally-conductive sidewall region and said thermally-conductive bottom region of said interior compartment and said least one thermally-insulative sidewall region and said thermally-insulative bottom region, and
wherein said thermally-insulative material is a reflective metalized polymeric bubble pack sheet.

59. The flexible container of claim 58, wherein said sheet of thermally-insulative material is folded and sealed near the respective lateral edges thereof, said fold being the thermally-insulative bottom region.

60. The flexible container of claim 58, wherein the respective lateral edges of said thermally-conductive sheet and said thermally-insulative sheet, when folded, are sealed so as to form two sealable outer compartments.

61. The flexible container of claim 58, wherein said thermally-conductive bottom region and said thermally-insulative bottom region are coupled to form two distinct outer compartments.

62. The flexible container of claim 58, wherein said thermally-conductive bottom region and said thermally-insulative bottom region are hermetically and selectively reversibly coupled to form two distinct outer compartments.

63. The flexible container of claim 58, wherein one of said hermitically-sealed outer compartments is filled with a first substance and the other of said hermitically-sealed outer compartments is filled with a second substance, wherein the first and second substances are permitted to contact one another upon selective uncoupling of said thermally-conductive bottom region and said thermally-insulative bottom region, and wherein said first substance and said second substance chemically react when in contact.

64. The flexible container of claim 63, wherein said first substance and said second substance chemically react endothermically.

65. A method for producing a thermally-insulative flexible container comprising;
providing a thermally-insulative sheet in layered arrangement with a thermally-conductive sheet of equal or lesser dimensions, wherein the thermally-insulative sheet is a reflective metalized polymeric bubble pack sheet;
folding said thermally-insulative sheet and said thermally-conductive sheet together such that the thermally-conductive sheet is inside the thermally-insulative sheet;
sealing the near lateral sides of the thermally-conductive sheet and the laterals sides of the thermally-insulative sheet such that the thermally-conductive sheet forms an interior compartment and the thermally-insulative sheet forms one or more exterior compartments with void therebetween; and
installing in the void a material capable of exchanging heat with the interior compartment across the thermally-conductive sheet and sealing the void so as to contain the material capable of exchanging heat in the void.

66. The method of claim 65, wherein the interior compartment is reversibly sealable.

67. The method of claim 65, wherein the sealing near the lateral sides of the thermally-conductive sheet and the thermally-insulative sheet joins the lateral sides of the thermally-conductive sheet to the thermally-insulative sheet so as to define at least two outer voids.

68. The method of claim 65, wherein the fold of the thermally-insulative sheet and the fold of the thermally-conductive sheet are coupled.
